(19) United States
(12) Patent Application Publication
(10) Pub. No.: US 2023/0156665 A1
(43) Pub. Date: May 18, 2023

(54) METHODS, DEVICES AND COMPUTER STORAGE MEDIA FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/920,614

(22) PCT Filed: Apr. 24, 2020
(86) PCT No.: PCT/CN2020/086587

§ 371 Date: Oct. 21, 2022

(51) Int. Cl. H04W 72/02; H04L 5/00; H04W 72/20

(52) U.S. Cl. CPC H04W 72/02; H04L 5/0053; H04L 5/0091; H04W 72/20

(57) ABSTRACT

Embodiments of the present disclosure relate to methods, devices and computer storage media for communication. A method comprises determining, at a terminal device, a resource configuration for control information on a channel between the terminal device and a network device, the resource configuration being associated with a plurality of Transmission Configuration Indicator (TCI) states for the channel; and detecting a plurality of repetitions of the control information on the channel from the network device based on the resource configuration, a TCI state of the plurality of TCI states corresponding to at least one of the plurality of repetitions. Embodiments of the present disclosure can improve reliability and robustness for Physical Downlink Control Channel (PDCCH).

### TECHNICAL FIELD

Embodiments of the present disclosure generally relate to the field of telecommunication, and in particular, to methods, devices and computer storage media for control channel repetitions.

### BACKGROUND

In the 3rd Generation Partnership Project (3GPP) meeting RAN#86, enhancements on the support for multi-Transmission and Reception Point (multi-TRP) deployment targeting both FR 1 and FR2 have been discussed. For example, it has been proposed to identify and specify features to improve reliability and robustness for channels (such as, Physical Downlink Control Channel (PDCCH), Physical Uplink Shared Channel (PUSCH) and Physical Uplink Control Channel (PUCCH)) other than Physical Downlink Shared Channel (PDSCH) using multi-TRP and/or multi-panel with Release 16 reliability features as a baseline. It has also been proposed to identify and specify features to enable inter-cell multi-TRP operations. It has also been proposed to evaluate and specify enhancements for simultaneous multi-TRP transmission with multi-panel reception.

In the 3GPP meeting RAN1#98-99, it has been proposed to support PDCCH repetitions to improve reliability and robustness for the PDCCH. That is, a PDCCH signal (such as, downlink control information, DCI) can be repeatedly transmitted from a network device to a terminal device more than once, so as to improve reliability and robustness for the PDCCH. However, no detail about PDCCH repetitions has been discussed or specified.

### SUMMARY

In general, example embodiments of the present disclosure provide methods, devices and computer storage media for control channel repetitions.

In a first aspect, there is provided a method of communication. The method comprises determining, at a terminal device, a resource configuration for control information on a channel between the terminal device and a network device, the resource configuration being associated with a plurality of Transmission Configuration Indicator (TCI) states for the channel; and detecting a plurality of repetitions of the control information on the channel from the network device based on the resource configuration, a TCI state of the plurality of TCI states corresponding to at least one of the plurality of repetitions.

In a second aspect, there is provided a method of communication. The method comprises determining, at a network device, a resource configuration for transmitting control information on a channel between a terminal device and the network device, the resource configuration being associated with a plurality of Transmission Configuration Indicator (TCI) states for the channel; and transmitting to the terminal device a plurality of repetitions of the control information on the channel based on the resource configuration, a TCI state of the plurality of TCI states corresponding to at least one of the plurality of repetitions.

In a third aspect, there is provided a terminal device. The terminal device comprises a processor and a memory. The memory is coupled to the processor and stores instructions thereon. The instructions, when executed by the processor, cause the terminal device to perform acts comprising determining a resource configuration for control information on a channel between the terminal device and a network device, the resource configuration being associated with a plurality of Transmission Configuration Indicator (TCI) states for the channel; and detecting a plurality of repetitions of the control information on the channel from the network device based on the resource configuration, a TCI state of the plurality of TCI states corresponding to at least one of the plurality of repetitions.

In a fourth aspect, there is provided a network device. The network device comprises a processor and a memory. The memory is coupled to the processor and stores instructions thereon. The instructions, when executed by the processor, cause the network device to perform acts comprising determining a resource configuration for transmitting control information on a channel between a terminal device and the network device, the resource configuration being associated with a plurality of Transmission Configuration Indicator (TCI) states for the channel; and transmitting to the terminal device a plurality of repetitions of the control information on the channel based on the resource configuration, a TCI state of the plurality of TCI states corresponding to at least one of the plurality of repetitions.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrate an example communication network in which embodiments of the present disclosure can be implemented;

FIG. 2 illustrates an example of time and frequency domain resources configured for PDCCH;

FIG. 3 illustrates an example process for communication in accordance with some embodiments of the present disclosure;

FIG. 4 illustrates an example of PDCCH repetitions in accordance with some embodiments of the present disclosure;

FIG. 5A illustrates an example of PDCCH repetitions in accordance with some embodiments of the present disclosure;

FIG. 5B illustrates an example of PDCCH repetitions in accordance with some embodiments of the present disclosure;

FIG. 6 illustrates an example of PDCCH repetitions in accordance with some embodiments of the present disclosure;

FIG. 7 illustrates an example of PDCCH repetitions in accordance with some embodiments of the present disclosure;

FIG. 8 illustrates an example of PDCCH repetitions in accordance with some embodiments of the present disclosure;

FIG. 9 illustrates a flowchart of an example method in accordance with some embodiments of the present disclosure;

FIG. 10 illustrates a flowchart of an example method in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or DCI.

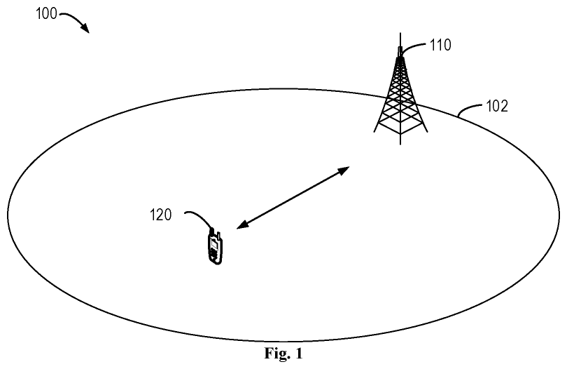

FIG. 1 shows an example communication network 100 in which embodiments of the present disclosure can be implemented. The network 100 includes a network device 110, a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing embodiments of the present disclosure. Although not shown, it would be appreciated that one or more terminal devices may be in the cell 102 and served by the network device 110.

In the communication network 100, the network device 110 can communicate/transmit data and control information to the terminal device 120 and the terminal device 120 can also communicate/transmit data and control information to the network device 110. A link from the network device 110 to the terminal device 120 is referred to as a downlink (DL), while a link from the terminal device 120 to the network device 110 is referred to as an uplink (UL).

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

In the network 100, the network device 110 may transmit control information via a PDCCH to the terminal device 120. In the case where PDCCH repetitions is configured or enabled, a PDCCH signal carrying the same DCI can be repeatedly transmitted from the network device 110 to the terminal device 120 more than once, so as to improve reliability and robustness for the PDCCH.

As mentioned above, although it has been agreed to support PDCCH repetitions, there is no detail on how the PDCCH repetitions are designed. Moreover, Multi Input Multi Output (MIMO) includes features that facilitate utilization of a large number of antenna elements at base station for both sub-6 GHz and over-6 GHz frequency bands. In Release 17, channels other than PDSCH can benefit from multi-TRP transmission (as well as multi-panel reception) which also includes multi-TRP for inter-cell operations. As such, PDCCH can benefit from the multi-TRP transmission. In particular, when multi-TRP is used for PDCCH repetitions, or in other words, when multiple Transmission Configuration Indicator (TCI) states are used for PDCCH repetitions, how to configure the time/frequency resource (e.g. the control resource set and/or search space) for repeated PDCCHs still remains an issue.

A TCI state may indicate one Reference Signal (RS) set as well as parameters that configure quasi co-location (QCL) relationship between RSs within the RS set and Demodulation Reference Signal (DMRS) ports for a PDCCH. In the following, the terms “TCI state”, “set of QCL parameter(s)”, “QCL parameter(s)”, “set of QCL configuration(s)”, “QCL configuration(s)”, “set of QCL information”, “QCL information”, and “QCL assumption” can be used interchangeably. Moreover, in the following, “TCI state” is used to describe embodiments of the present disclosure for convenience.

As specified in the 3GPP specifications (TS 38.214), a UE (as an example of the terminal device) can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DMRS ports of the PDSCH, the DMRS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay};
‘QCL-TypeD’: {Spatial Rx parameter}.

Embodiments of the present disclosure provide a solution to solve the above problem and/or one or more of other potential problems. In this solution, when a plurality of TCI states are used for PDCCH repetitions, a resource configuration may be associated with the plurality of TCI states. The plurality of PDCCH repetitions may be detected based on the resource configuration and a TCI state of the plurality of TCI states may correspond to at least one of the plurality of PDCCH repetitions. In some embodiments, a search space may be associated with the plurality of TCI states. The plurality of PDCCH repetitions may be detected within a transmission occasion of the search space in a manner of frequency division multiplexing (FDM) and/or time division multiplexing (TDM) and/or spatial division multiplexing (SDM). Alternatively or additionally, the plurality of PDCCH repetitions may be detected across different transmission occasions of the search space. In some embodiments, a CORESET may be associated with the plurality of TCI states. The plurality of PDCCH repetitions may be detected across a plurality of search spaces associated with CORESET. In some embodiments, a plurality of CORESETs may be associated with the plurality of TCI states with each CORESET being associated with a respective TCI state. The plurality of PDCCH repetitions may be detected across the plurality of CORESETs. In this way, reliability and robustness for PDCCH can be improved in case of PDCCH repetitions.

To better understand the solution of PDCCH repetitions proposed by the present disclosure, the design of PDCCH is first introduced here. The frequency domain resources and time duration (in number of symbols) for PDCCH monitoring are defined as a control resource set (CORESET). The configuration of the CORESET may be configured to the terminal device 120 via higher layer signaling, for example via Radio RRC signaling in the information element (IE) ControlResourceSet. The IE ControlResourceSet is used to configure a time/frequency resource in which to search for DCI.

The higher layer parameter duration in the IE ControlResourceSet defines contiguous time duration of the CORESET in number of symbols. The higher layer parameter frequencyDomainResources in the IE ControlResourceSet defines frequency domain resources for the CORESET. Each bit corresponds to a group of 6 resource blocks (RBs), with grouping starting from the first RB group in the bandwidth part (BWP). The first (left-most/most significant) bit corresponds to the first RB group in the BWP, and so on. A bit that is set to 1 indicates that this RB group belongs to the frequency domain resource of this CORESET. Bits corresponding to a group of RBs not fully contained in the bandwidth part within which the CORESET is configured are set to zero.

The slots and starting symbol within a slot for PDCCH monitoring are defined as a search space. The configuration of the search space may be configured to the terminal device 120 via higher layer signaling, for example via RRC signaling in the IE SearchSpace. The IE SearchSpace defines how/where to search for PDCCH candidates. Each search space is associated with one CORESET, while a CORESET may be associated with more than one search space.

The higher layer parameter duration in the IE SearchSpace defines the number of consecutive slots that a SearchSpace lasts in every occasion, i.e., upon every period as given in the parameter periodicityAndOffset. If the field is absent, the terminal device 120 applies the value 1 slot, except for DCI format 2_0. The terminal device 120 ignores this field for DCI format 2_0. The maximum valid duration is periodicity−1 (periodicity as given in the parameter monitoringSlotPeriodicityAndOffset). For example, the maximum valid duration may be 2560.

The higher layer parameter monitoringSlotPeriodicityAndOffset in the IE SearchSpace defines slots for PDCCH Monitoring configured as periodicity and offset. If the terminal device 120 is configured to monitor DCI format 2_1, only the values ‘sl1’, ‘sl2’ or ‘sl4’ are applicable. If the terminal device 120 is configured to monitor DCI format 2_0, only the values ‘sl1’, ‘sl2’, ‘sl4’, ‘sl5’, ‘sl8’, ‘sl10’, ‘sl16’, and ‘sl20’ are applicable.

The higher layer parameter monitoringSymbolsWithinSlot in the IE SearchSpace defines the first symbol(s) for PDCCH monitoring in the slots configured for PDCCH monitoring (see the parameters monitoringSlotPeriodicityAndOffset and duration). The most significant (left) bit represents the first OFDM in a slot, and the second most significant (left) bit represents the second OFDM symbol in a slot and so on. The bit(s) set to one identify the first OFDM symbol(s) of the control resource set within a slot. If the cyclic prefix of the BWP is set to extended cyclic prefix (CP), the last two bits within the bit string shall be ignored by the terminal device 120. For DCI format 2_0, the first one symbol applies if the duration of CORESET (in the IE ControlResourceSet) identified by controlResourceSetId indicates 3 symbols, the first two symbols apply if the duration of CORESET identified by controlResourceSetId indicates 2 symbols, and the first three symbols apply if the duration of CORESET identified by controlResourceSetId indicates 1 symbol.

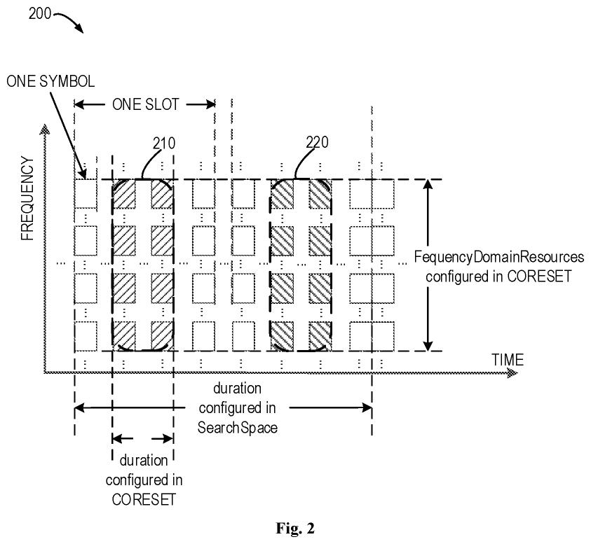

FIG. 2 illustrates a schematic diagram 200 showing time and frequency domain resources configured for PDCCH. FIG. 2 illustrates PDCCH candidates 210 and 220 as defined by a CORESET and a search space. The terminal device 120 may monitor the PDCCH candidates 210 and 220 for DCI from the network device 110.

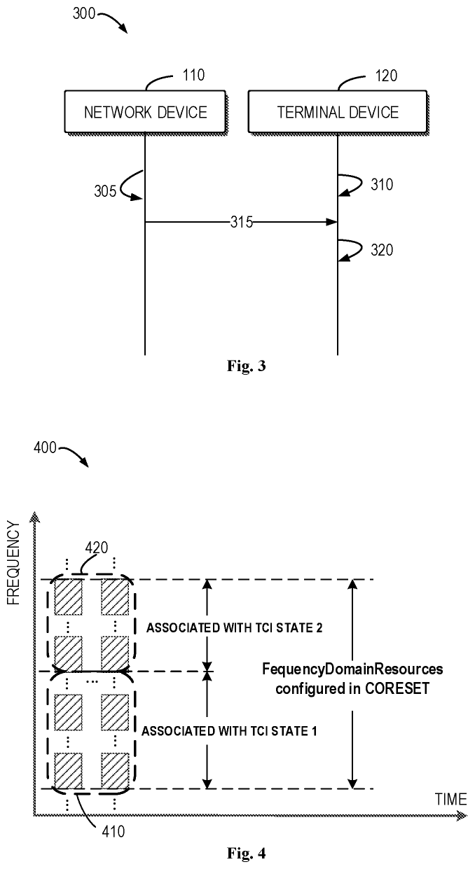

To better understand the solution for PDCCH repetitions, some embodiments are now described with reference to FIGS. 3-10. A general framework for PDCCH repetitions when multiple TCI states are enabled is first described. M PDCCH repetitions are associated with N TCI states, where M and N are positive integer. In some embodiments, the value of N may have a range from 2 to 4, that is, 2<=N<=4. For example, N may have a value of 2. For example, two beams will be used for PDCCH. In some embodiments, the value of M may have a range from 2 to 16, that is, 2<=M<=16. For example, M may have a value of 2, which means two PDCCH repetitions for the same DCI. In some embodiments, M may be equal to N. In such embodiments, for one TCI state, there may be only one PDCCH repetition.

In some embodiments, for the PDCCH repetitions, at least one of the following parameters/configurations may be same: PDCCH format, value of control channel element (CCE) aggregation level, value of RNTI, CCE to Resource Element Group (REG) mapping type, precoder granularity, duration in CORESET, duration in search space, frequencyDomainResources (as described above), monitoringSlotPeriodicityAndOffset (as described above), monitoringSymbolsWithinSlot (as described above).

For example, when PDCCH repetition is configured, the same CCE-to-REG mapping type may be used for the PDCCH repetitions. As an example, CCE-to-REG mapping type can only be configured as the interleaved mapping type at least for Frequency Division Multiplexed (FDMed) repetition, or repetitions within one search space. As another example, CCE-to-REG mapping type can only be configured as the non-interleaved mapping type at least for FDMed repetition, or repetitions within one search space.

For example, when PDCCH repetition is configured, the same precoderGranularity may be configured for the PDCCH repetitions. As an example, the precoderGranularity can only be configured as allContiguousRBs or sameAsREG-bundle at least for FDMed repetition, or repetitions within one search space.

An example process is now described with reference to FIG. 3, which is a schematic diagram illustrating an example process 300 in accordance with some embodiments of the present disclosure. As shown in FIG. 3, the example process 300 may involve the network device 110 and the terminal device 120. It is to be understood that the process 300 may include additional acts not shown and/or may omit some acts as shown, and the scope of the present disclosure is not limited in this regard. PDCCH repetition and a plurality of TCI states are enabled.

As shown in FIG. 3, the network device 110 determines 305 a resource configuration for control information on the PDCCH between the terminal device 120 and the network device 110. The resource configuration is associated with a plurality of TCI states (such as 2 TCI states) or a plurality of sets of QCL parameters or a plurality of QCL parameters for PDCCH. The resource configuration may be at least one of a CORESET and search space. The network device 110 transmits 315 to the terminal device 120 a plurality of repetitions of the control information on the PDCCH based on the resource configuration. A TCI state of the plurality of TCI states corresponds to at least one of the plurality of repetitions. For example, the same DCI may be transmitted more than once to the terminal device 120 via the PDCCH repetitions.

The terminal device 120 also determines 310 the resource configuration for control information on the PDCCH between the terminal device 120 and the network device 110. For example, the terminal device 120 may determine the resource configuration from higher layer signaling. The terminal device 120 detects 320 the plurality of repetitions of the control information on the PDCCH based on the resource configuration. In other words, the terminal device 120 may detect the PDCCH repetitions.

In the above example process 300, the resource configuration concerning PDCCH repetitions is determined at terminal device 120 and the terminal device 120 may detect the PDCCH repetitions based on the determined resource configuration. In the following, some example embodiments are detailed to illustrate how to configure or allocate the resources for PDCCH repetitions when a plurality of TCI states are enabled for the PDCCH repetitions. For purpose of discussion, the plurality of TCI states may be referred to as N TCI states hereinafter.

In some embodiments, a search space may be associated with N TCI states. In such embodiments, PDCCH may be repeated within the search space. The N TCI states may be activated for the search space and/or the CORESET associated with the search space. In some embodiments, PDCCH may be repeated within the duration of each occasion/period of the search space. Accordingly, the terminal device 120 may detect the plurality of PDCCH repetitions within a transmission occasion of the search space. In some embodiments, PDCCH may be repeated across different occasions/periods of the search space. Accordingly, the terminal device 120 may detect the plurality of PDCCH repetitions within different transmission occasions of the search space.

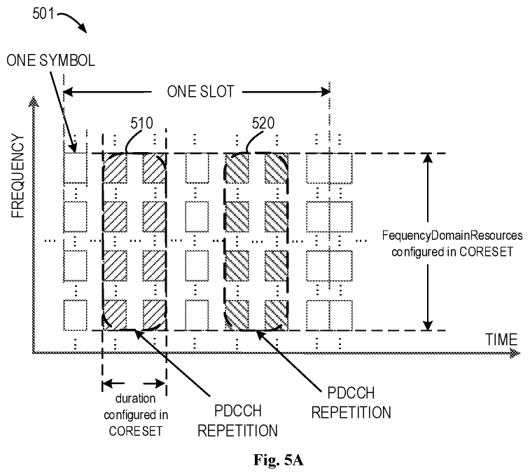

Reference is now made to FIGS. 4-6 to describe some example embodiments where PDCCH may be repeated within the duration of each occasion/period of the search space. In some embodiments, the type of PDCCH repetition may be configured as FDM and the frequency domain resources configured for the associated CORESET may be assigned among the N TCI states.

Allocation of the frequency domain resources to the N TCI states may depend on the granularity of precoder. If the higher-layer parameter precoderGranularity is configured as allContiguousRBs, contiguous REGs/RBs may be assigned to each of the N TCI states. An example where the number of TCI states N is equal to 2 is described to illustrate how to assign/configure the frequency domain resources.

As an example, the first [N_REG/2] or [N_REG/2] REGs/RBs may be assigned to or associated with a first TCI state (which may be also referred to as TCI state 1), and the remaining [N_REG/2] or [N_REG/2] REGs may be assigned to or associated with a second TCI state (which may be also referred to as TCI state 2). N_REG is the number of REGs or RBs within one symbol for the frequency domain resources configured for the associated CORESET. Alternatively, N_REG=6*B, where B is the number of bits which are set to 1 and configured in higher layer parameter frequencyDomainResources in ControlResourceSet, as described above.

As another example, the first [N_REG/(2*S)] or [N_REG/(2*S)] REGs may be assigned to or associated with TCI state 1, and the remaining [N_REG/(2*S)] or [N_REG/(2*S)] REGs may be assigned to or associated with TCI state 2. N_REG is the number of REGs or RBs for the frequency domain resources configured for the associated CORESET, and S is the number of symbols for the associated CORESET. Alternatively, N_REG=6*B*S, where B is the number of bits which are set to 1 and configured in higher layer parameterfrequencyDomainResources in ControlResourceSet, and S is the number of symbols for the associated CORESET.

As a further example, the first [B/2] or [B/2] RB groups or 3*B REGs/RBs may be assigned to or associated with TCI state 1, and the remaining [B/2] or [B/2] RB groups or 3*B REGs/RBs are assigned to or associated with TCI state 2. B is the number of bits which are set to 1 and configured in higher layer parameter frequencyDomainResources in ControlResourceSet. Alternatively, the first [C/2] or [C/2] CCEs may be assigned to or associated with to TCI state 1, and the remaining [C/2] or [C/2] CCEs may be assigned to or associated with TCI state 2. C is the number of CCEs in the associated CORESET

Reference is made to FIG. 4, which illustrates an example of PDCCH repetitions in accordance with some embodiments of the present disclosure. As shown in FIG. 4, the frequency domain resources configured in a CORESET are assigned between TCI state 1 and TCI state 2. As shown, the REGs with lower frequencies are associated with TCI state 1 and the REGs with higher frequencies are associated with TCI state 2. If one TCI state is associated with one of the PDCCH repetitions, the terminal device 120 may detect the PDCCH repetition 410 with TCI state 1 and the PDCCH repetition 420 with TCI state 2.

If the higher-layer parameter precoderGranularity is configured as sameAsREG-bundle, the frequency domain resources may be assigned to the N TCI states in granularity of REG bundle. As an example, REG bundles or CCEs with even indexes may be assigned to or associated with TCI state 1, and REG bundles or CCEs with odd indexes may be assigned to or associated with to TCI state 2. As another example, REG bundles with odd indexes or CCEs may be assigned to or associated with TCI state 1, and REG bundles or CCEs with even indexes may be assigned to or associated with TCI state 2.

In the above examples, the RB/REG/RB group/CCE may be indexed from lower frequency to higher frequency. B may be indexed from left to right in the bit string configured for frequencyDomainResources. For example, this may be applicable at least when CCE-to-REG mapping type is non-interleaved mapping type.

In some embodiments, when CCE-to-REG mapping type is configured as interleaved mapping type, the CCE-to-REG mapping may be interleaved within the REGs or the REG bundles assigned to or associated with one of the N TCI states. A CORESET may consist of N_{RB}^{CORESET} resource blocks in the frequency domain and N_{symb}^{CORESET}∈{1,2,3} symbols in the time domain. For interleaved CCE-to-REG mapping, L∈{2,6} for N_{symb}^{CORESET}=1 and L∈{N_{symb}^{CORSET},6} for N_{symb}^{CORESET}∈{2,3}. For example, if PDCCH repetition is configured, the interleaver may be defined by

f(x)=(rC+c+n_{shift})mod(X/L)

x=cR+r

r=0,1, . . . ,R−1

c=0,1, . . . ,C−1

C=X/(LR) (1)

where R∈{2,3,6}. X is the number of RBs or REGs associated with one of the N TCI states if the N TCI states are activated for the CORESET. Otherwise, X=N_{RB}^{CORESET}.

In some embodiments, the type of PDCCH repetition may be configured as TDM and PDCCH may be repeated within the duration configured for the search space. The terminal device 120 may detect the PDCCH repetitions across different time intervals within the duration of the search space. The number of PDCCH repetitions and the assignment of the time domain resource may depend on the specific configuration of the search space, for example the duration of each occasion and/or first symbol(s) for PDCCH monitoring in the duration. For example, the number of PDCCH repetitions may depend on the value of the higher layer parameter duration and/or the value of the higher layer parameter monitoringSymbolsWithinSlot.

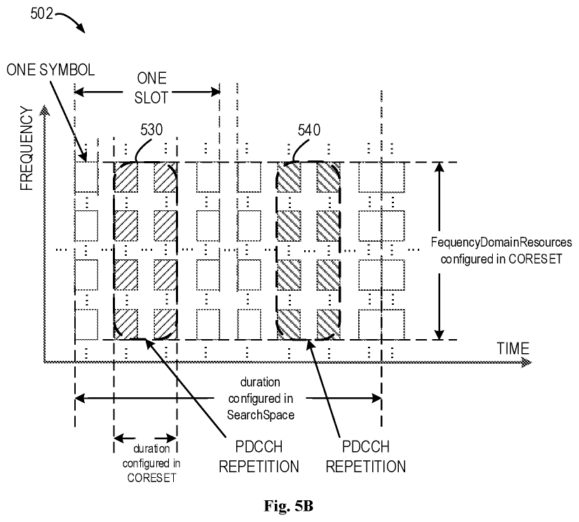

As an example, if each occasion of the search space lasts 1 slot, or in other words, the value of the parameter duration is 1 slot (for example, the IE field duration absent in SearchSpace), only intra-slot repetition can be applied. For example, in this case, the number or the maximum number of PDCCH repetitions (which may be represented by Nr) may depend on the number of the first symbol(s) for PDCCH monitoring in the slots configured for PDCCH monitoring. In other words, the number or the maximum number of PDCCH repetitions may depend on the number of bits set to 1 in IE monitoringSymbolsWithinSlot. For example, Nr may be equal to or no larger than Nb, where Nb is the number of bits set to 1 in IE monitoringSymbolsWithinSlot. For another example, in this case, if the number or the maximum number of PDCCH repetitions (which may be represented by Nr) is configured to be larger than the number of the first symbol(s) for PDCCH monitoring in the slots configured for PDCCH monitoring or larger than the number of bits set to 1 in IE monitoringSymbolsWithinSlot, for example, if Nr is configured to be larger than Nb, where Nb is the number of bits set to 1 in IE monitoringSymbolsWithinSlot, then up to Nb repetitions will be transmitted from the network device 110 to the terminal device 120. Alternatively, the remaining Nr-Nb configured repetitions will be dropped or will not be transmitted. FIG. 5A illustrates such an example of PDCCH repetitions. As shown in FIG. 5A, the terminal device 120 may detect the PDCCH repetitions 510 and 520 within one slot. Each of PDCCH repetitions 510 and 520 may be detected within the duration configured in the associated CORESET.

As another example, if each occasion of the search space lasts more than 1 slot, or in other words, the value of the parameter duration is larger than 1 slot, inter-slot repetition can be applied. For example, in this case, the number or the maximum number of PDCCH repetitions (which may be represented by Nr) may depend on the number of slots of the duration configured in the search space. For example, there may exist one of the PDCCH repetitions within one slot. The number or the maximum number of PDCCH repetitions may be equal to or no larger than the number of slots of the duration configured in the search space. For example, Nr=Ns or Nr is no larger than Ns, where Ns is the value of the parameter duration in the IE SearchSpace. For another example, in this case, if the number or the maximum number of PDCCH repetitions (which may be represented by Nr) is configured to be larger than the number of slots of the duration configured in the search space or larger than the value of the parameter duration in the IE SearchSpace, for example, if Nr is configured to be larger than Ns, where Ns is the value of the parameter duration in the IE SearchSpace, then up to Ns repetitions will be transmitted from the network device 110 to the terminal device 120. Alternatively, the remaining Nr-Ns configured repetitions will be dropped or will not be transmitted. FIG. 5B illustrates such an example of PDCCH repetitions. As shown in FIG. 5B, the terminal device 120 may detect the PDCCH repetitions 530 and 540 across more than one slot within the duration configured in the search space. Each of PDCCH repetitions 530 and 540 may be detected within the duration configured in the associated CORESET.

As a further example, a combination of inter-slot and intra-slot repetition may be applied. In this case, the terminal device 120 may detect the PDCCH repetitions both within one slot and across slots. For example, the number or maximum number of the PDCCH repetitions may depend on both the number of slots of the duration configured in the search space and the number of the first symbol(s) for PDCCH monitoring in the slots. For example, Nr=Ns*Nb, or Nr≤Ns*Nb. For another example, if Nr is configured to be larger than Ns*Nb, then up to Ns*Nb repetitions will be transmitted from the network device 110 to the terminal device 120. Alternatively, the remaining Nr−Ns*Nb configured repetitions will be dropped or will not be transmitted.

In some embodiments, if PDCCH repetition (for example, across occasions/periods) is configured, only a subset of values for the number of consecutive slots that a search space lasts in every occasion can be configured. For example, the subset of values for the number of consecutive slots that a search space lasts in every occasion may comprise at least one of {1, 2, 3, 4, 5, 6, 7, 8, 9, 10, 11, 12, 13, 14, 15, 16, 17, 18, 19, 20} slots. Alternatively or additionally, if PDCCH repetition (for example, across occasions/periods) is configured, absence of the parameter duration in the IE SearchSpace and/or only a subset of values for duration in the IE SearchSpace will be applicable. For example, the subset of values for duration in the IE SearchSpace may comprise at least one of {1, 2, 3, 4, 5, 6, 7, 8, 9, 10, 11, 12, 13, 14, 15, 16, 17, 18, 19, 20}. In other words, in the case where PDCCH repetition (for example, across occasions/periods) is configured, the network device 110 may not configure the parameter duration in the IE SearchSpace or configure the parameter duration in the IE SearchSpace based on the subset of values, for example {1, 2, 3, 4, 5, 6, 7, 8, 9, 10, 11, 12, 13, 14, 15, 16, 17, 18, 19, 20}.

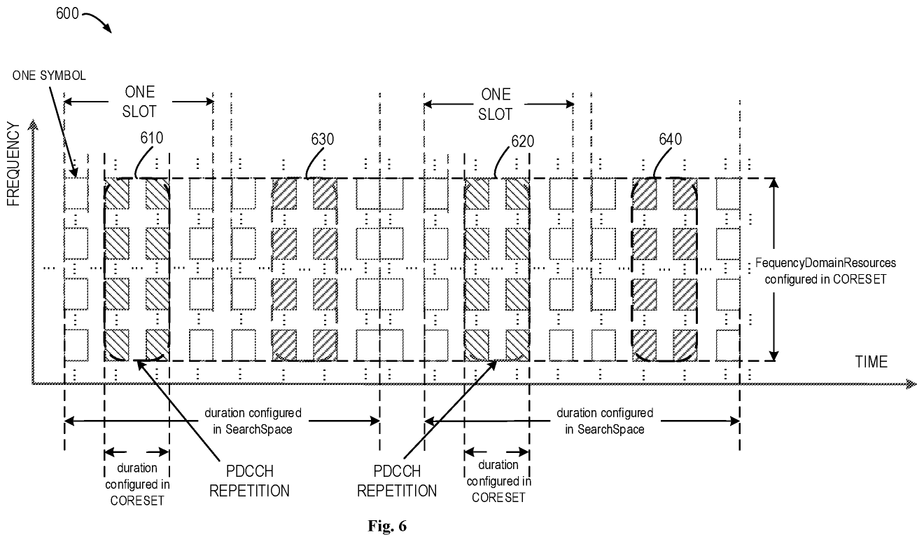

In the above embodiments, a search space is associated with N TCI states and PDCCH is repeated within the duration of each occasion/period of the search space. Alternatively or additionally, PDCCH may be repeated across different occasions or periods of the search space. The terminal device 120 may detect the PDCCH repetitions across different transmission occasions of the search space. As an example of such embodiments, there may be one of the PDCCH repetitions in one occasion or period of the search space. Reference is made to FIG. 6, which illustrates an example of PDCCH repetitions in accordance with some embodiments of the present disclosure. In this example, the terminal device 120 may detect the PDCCH repetitions 610 and 620 across different occasions of the search space.

As another example, there may be more than one PDCCH repetition in one occasion. In this case, the terminal device 120 may detect the PDCCH repetitions both within an occasion and across occasions. For example, as shown in FIG. 6, the terminal device 120 may detect the PDCCH repetitions 610, 620, 630 and 640, where the PDCCH repetitions 610 and 620 are detected in the same occasion and the PDCCH repetitions 630 and 640 are detected in the same occasion.

Since the spacing in time between two repetitions cannot be too long, there may be a constraint on slots for PDCCH monitoring configured as periodicity and offset when PDCCH repetition across occasions/periods is configured. For example, if PDCCH repetition (for example, across occasions/periods) is configured, only a subset of values for PDCCH monitoring periodicity can be configured. For example, the subset of values for PDCCH monitoring periodicity may comprise at least one of {1, 2, 3, 4, 5, 8, 10, 16, 20} slots. For example, if PDCCH repetition (for example, across occasions/periods) is configured, only a subset of values for monitoringSlotPeriodicityAndOffset will be applicable. For example, the subset may comprise at least one of {‘sl1’, ‘sl2’, ‘sl4’, ‘sl5’, ‘sl8’, ‘sl10’, ‘sl16’, ‘sl20’ }. In other words, in the case where PDCCH repetition (for example, across occasions/periods) is configured, the network device 110 may configure the parameter monitoringSlotPeriodicityAndOffset based on the subset of values, for example {‘sl1’, ‘sl2’, ‘sl4’, ‘sl5’, ‘sl8’, ‘sl10’, ‘sl16’, ‘sl20’ }.

Although PDCCH repetitions configured as FDM and PDCCH repetitions TDM are described separately in the above embodiments, in some embodiments, PDCCH repetitions may be configured as both FDM and TDM. In this case, aspects described above with respect to different embodiments can be combined.

In the above embodiments, the search space is associated with the plurality of TCI states. Alternatively or additionally, in some embodiments, a CORESET may be associated with the plurality of TCI states, which may be referred to as N TCI states. The PDCCH may be repeated within the CORESET and across search spaces. In this case, the terminal device 120 may detect the plurality of PDCCH repetitions across a plurality of search spaces associated with the CORESET.

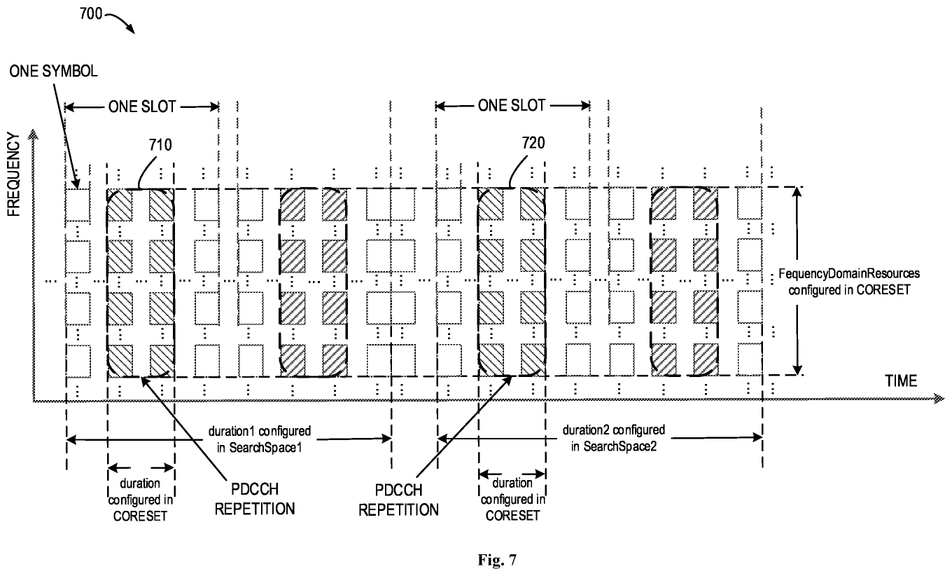

The number of search spaces associated with the CORESET for PDCCH repetition may be related to (for example, be equal to) the number of the plurality of TCI states. As an example, N search spaces may be associated with or configured for PDCCH repetition, and one of the plurality of PDCCH repetitions may be detected within one search space. FIG. 7 illustrates such an example. As shown in the FIG. 7, the PDCCH repetition 710 may be detected within the duration of the first search space (shown as “duration 1 configured in Search Space 1”) and the PDCCH repetition 720 may be detected within the duration of the second search space (shown as “duration 2 configured in Search Space 2”).

In some embodiments, the plurality of search spaces associated with the CORESET (which may be referred to N search spaces herein) may be are configured with the same periodicity and/or duration in the IE SearchSpace. Alternatively or additionally, the N search spaces may be configured with different values of slot offset and/or symbol offset within a slot. For example, the value of slot offset for the N search spaces may be expected to be less than a predefined value F, where F may be a non-negative integer. In an example, the value of F may have a range between 0 and 20, i.e., 0<=F<=20.

In some embodiments, instead of using the parameters already defined in the IE SearchSpace, an additional parameter for slot offset and/or an additional parameter for symbol offset may be configured for the N search spaces. For example, a new parameter “slotoffset” and/or a new parameter “symboloffset” may be configured for the N search spaces. For example, the value of the new parameter “slot offset” may be at least one of {0, 1, 2, 3, 4, 5, 6, 7, 8, 9, 10, 11, 12, 13, 14, 15, 16, 17, 18, 19, 20}.

In the above embodiments, a CORESET is associated with the plurality of TCI states. In some other embodiments, a plurality of CORESETs may be associated with the plurality of TCI states. Each of the plurality of CORESETs may be associated with a respective one of the plurality of TCI states. For example, N CORESETs may be associated with N TCI states, and one CORESET of the N CORESETs may be associated with a respective one of the N TCI states. In this case, PDCCH may be repeated across the plurality of CORESETs with one repetition located within one CORESET. The terminal device 120 may detect the plurality of PDCCH repetitions across the plurality of CORESETs.

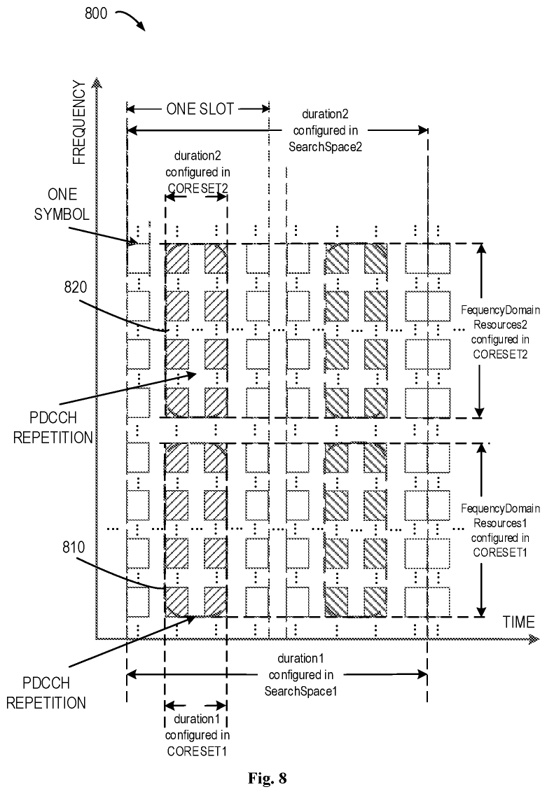

As an example, N search spaces each associated with one of the N CORESETs may be associated with or configured for the PDCCH repetition. The N CORESETs may be configured with same time duration. For example, the value of the parameter duration in the IE ControlResourceSet may be configured as the same for the N CORESETs. FIG. 8 illustrates such an example. As shown in FIG. 8, the PDCCH repetitions 810 and 820 may be detected across a first CORESET (shown as CORESET 1) and a second CORESET (shown as CORESET 1). A first search space shown as Search Space 1 is associated with CORESET 1 and a second search space shown as Search Space 2 is associated with CORESET 2.

In some embodiments, the N search spaces each associated with one of the N CORESETs may be are configured with the same periodicity and/or duration in the IE SearchSpace. Alternatively or additionally, the N search spaces may be configured with different values of slot offset and/or symbol offset within a slot. For example, the value of slot offset for the N search spaces may be expected to be less than a predefined value F, where F may be a non-negative integer. In an example, the value of F may have a range between 0 and 20, i.e., 0<=F<=20.

In some embodiments, instead of using the parameters already defined in the IE SearchSpace, an additional parameter for slot offset and/or an additional parameter for symbol offset may be configured for the N search spaces. For example, a new parameter “slotoffset” and/or a new parameter “symboloffset” may be configured for the N search spaces. For example, the value of the new parameter “slot offset” may be at least one of {0, 1, 2, 3, 4, 5, 6, 7, 8, 9, 10, 11, 12, 13, 14, 15, 16, 17, 18, 19, 20}. Alternatively or additionally, an additional parameter for RB/REG/CCE offset may be configured for the N CORESETs.

In the foregoing, allocation of resources to PDCCH repetitions is described with respect to some embodiments. It is to be understood that aspects of different embodiments can be combined. Which resource configuration(s) is enabled or activated for PDCCH repetitions may be indicated to the terminal device 120 by the network device 110 via RRC signaling or MAC CE for example.

When multiple TCI states are used for the PDCCH repetitions, indexing of resources for detecting PDCCH repetitions or monitoring PDCCH candidates may be defined accordingly. In some embodiments, for a search space set, the CCE indexes for PDCCH candidates of the search space set may be determined within the CCEs associated with one of the polarity of TCI states.

As an example, for a search space set s associated with CORESET P, the CCE indexes for aggregation level L corresponding to PDCCH candidate m_{s,n}_{_{CI}} of the search space set in slot n_{s,f}^{μ} for an active DL BWP of a serving cell corresponding to carrier indicator field value n_{CI} are given by

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{C I} ) mod ⌊ {N}_{CCE , p} / L ⌋ \} + i \qquad ( 2 )$$

where for any common search space (CSS), Y_{p,n}_{_{s,f}}_{^{μ}}=0; for a UE special search space (USS), Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for p mod 3=0, Aₚ=39829 for p mod 3=1, Aₚ=39839 for p mod 3=2, and D=65537; i=0, . . . , L−1; n_{CI} is the carrier indicator field value if the UE is configured with a carrier indicator field by CrossCarrierSchedulingConfig for the serving cell on which PDCCH is monitored; otherwise, including for any CSS, n_{CI}=0; m_{s,n}_{_{CI}}=0, . . . , M_{s,n}_{_{CI}}^{(L)}−1, where M_{s,n}_{_{CL}}^{(L)} is the number of PDCCH candidates the UE is configured to monitor for aggregation level L of a search space set s for a serving cell corresponding to n_{CI}; for any CSS, M_{s,max}^{(L)}=M_{s,0}^{(L)}; for a USS, M_{s,max}^{(L)} is the maximum of M_{s,n}_{_{CI}}^{(L)} over all configured ne, values for a CCE aggregation level L of search space set s; the RNTI value used for n_{RNTI} is the C-RNTI.

Specifically, N_{CCE,p} is the number of CCEs associated with one TCI state, numbered from 0 to N_{CCE,P}−1, in CORESET P. In this case, to detect the PDCCH repetitions, the terminal device 120 may determine indexes of the CCEs associated with one of the plurality of TCI states based on the number of the CCEs associated with the TCI state, as defined by the equation (2).

Although the equation (1) for interleaved CCE-to-REG mapping is described above with respect to the embodiments where PDCCH is repeated within duration of each occasion, the equation (1) is also applicable to other embodiments where the CCE-to-REG mapping is interleaved.

Some embodiments regarding PDCCH monitoring candidates which may be also referred to as PDCCH candidates are now described. In some embodiments, there may be a constraint on the total number of PDCCH candidates which are detected. In some embodiments, the priorities of PDCCH candidates for repeated PDCCH may be lower than the priorities of PDCCH candidates for CSS, and higher than the priorities of other PDCCH candidates. For example, if the total number of PDCCH candidates exceeds a threshold (e.g., a maximum number), the number of PDCCH candidates for repeated PDCCH which are detected by the terminal device 120 may depend on the number of PDCCH candidates for CSS. In some embodiments, the priorities of PDCCH candidates for repeated PDCCH may be lower than the priorities of PDCCH candidates for non-repeated PDCCH. In some embodiments, if the total number of PDCCH candidates exceeds a threshold (e.g., a maximum number), at least one of the PDCCH candidates for repeated PDCCH may be not monitored.

In some embodiments, for one aggregation level (AL), the total number of PDCCH candidates may be allocated among the plurality of TCI states. The number of PDCCH candidates allocated to each TCI state may be determined based on the number of TCI states used for PDCCH repetitions and the total number of PDCCH candidates.

In some embodiments, for a given value of aggregation level (as an example, in the case where the aggregation level is 8), N TCI states are used for PDCCH repetitions and the total number of PDCCH candidates is K, each TCI state may be allocated with K/N PDCCH candidates. As a specific example, if two TCI states are used for PDCCH repetitions, each TCI state may be allocated with K/2 PDCCH candidates.

As another example, different PDCCH candidates may correspond to different CCE indexes. In this way, time and frequency domain resources for different TCI states may be distinguished from each other without increasing the number of times for monitoring PDCCH candidates.

As a further example, the number of PDCCH repetitions may be configured per aggregation level. The same aggregation level may be assumed or configured for the plurality of PDCCH repetitions. For the plurality of PDCCH repetitions, available aggregation level may be limited. For example, the available aggregation level may be 4 or 8 or 16.

In some embodiments, if PDCCH repetition is configured, the PDCCH candidates for repeated PDCCH can only be TDMed. In some embodiments, if PDCCH repetition is configured, the PDCCH candidates for repeated PDCCH are not overlapped in time domain. For example, if at least one of the CORESETs and/or search spaces for the PDCCH candidates is associated to TCI-states with ‘QCL-TypeD’, the PDCCH candidates for repeated PDCCH may be not overlapped in time domain. For another example, if the PDCCH candidates for repeated PDCCH are associated to TCI-states with different ‘QCL-TypeD’, the PDCCH candidates for repeated PDCCH may be not overlapped in time domain.

As mentioned above, a TCI state may indicate one RS set as well as parameters that configure QCL relationship between RSs within the RS set and DMRS ports for a PDCCH. Therefore, aspects described above with respect to a plurality of TCI states may be applied to a plurality of sets of QCL parameters or a plurality of QCL parameters.

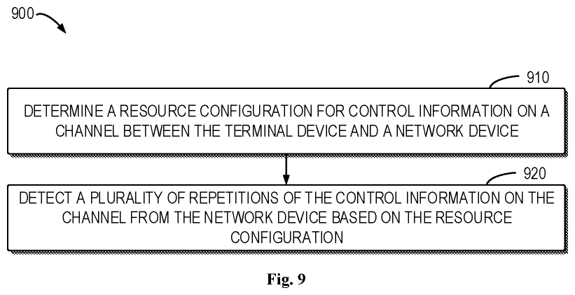

FIG. 9 illustrates a flowchart of an example method 900 in accordance with some embodiments of the present disclosure. The method 900 can be performed at the terminal device 120 as shown in FIG. 1. It is to be understood that the method 900 may include additional blocks not shown and/or may omit some blocks as shown, and the scope of the present disclosure is not limited in this regard.

At block 910, the terminal device 120 determines a resource configuration for control information on a channel between the terminal device and a network device 110. The resource configuration is associated with a plurality of Transmission Configuration Indicator (TCI) states for the channel. At block 920, the terminal device 120 detects a plurality of repetitions of the control information on the channel from the network device based on the resource configuration, a TCI state of the plurality of TCI states corresponding to at least one of the plurality of repetitions.

In some embodiments, determining the resource configuration comprises: determining a search space associated with the plurality of TCI states, and detecting the plurality of repetitions comprises: detecting the plurality of repetitions within a transmission occasion of the search space.

In some embodiments, detecting the plurality of repetitions within the transmission occasion of the search space comprises: determining, for a first TCI state of the plurality of TCI states, a first set of frequency domain resources configured for a control resource set associated with the search space; determining, for a second TCI state of the plurality of TCI states, a second set of frequency domain resources configured for the control resource set, the first set of frequency domain resources being non-overlapped with the second set of frequency domain resources in frequency domain; detecting a first repetition with the first TCI state using the first set of frequency domain resources; and detecting a second repetition with the second TCI state using the second set of frequency domain resources.

In some embodiments, detecting the plurality of repetitions within the transmission occasion of the search space comprises: determining a plurality of time intervals within the transmission occasion of the search space based on a time duration of a control resource set associated with the search space, the plurality of time intervals being non-overlapped with each other in time domain; and detecting a repetition of the plurality of repetitions within a respective one of the plurality of time intervals.

In some embodiments, determining the resource configuration comprises: determining a search space associated with the plurality of TCI states, and detecting the plurality of repetitions comprises: detecting the plurality of repetitions across different transmission occasions of the search space.

In some embodiments, determining the resource configuration comprises: determining a control resource set associated with the plurality of TCI states, and detecting the plurality of repetitions comprises: detecting the plurality of repetitions across a plurality of search spaces associated with the control resource set.

In some embodiments, determining the resource configuration comprises: determining a plurality of control resource sets, each of the plurality of control resource sets being associated with a respective one of the plurality of TCI states, and detecting the plurality of repetitions comprises: detecting the plurality of repetitions across the plurality of control resource sets.

In some embodiments, detecting the plurality of repetitions comprises: determining a number of control channel elements (CCEs) associated with a TCI state of the plurality of TCI states; determining indexes of the CCEs associated with the TCI state of the plurality of TCI states based on the number of the CCEs; and detecting a repetition of the plurality of repetitions corresponding to the TCI state based on the indexes.

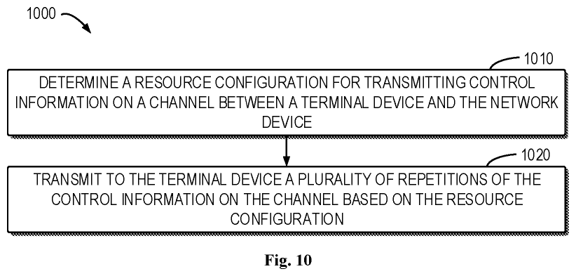

FIG. 10 illustrates a flowchart of an example method 1000 in accordance with some embodiments of the present disclosure. The method 1000 can be performed at the network device 110 as shown in FIG. 1. It is to be understood that the method 1000 may include additional blocks not shown and/or may omit some blocks as shown, and the scope of the present disclosure is not limited in this regard.

At block 1010, the network device 110 determines a resource configuration for transmitting control information on a channel between a terminal device 120 and the network device 110, the resource configuration being associated with a plurality of Transmission Configuration Indicator (TCI) states for the channel. At block 1020, the network device 110 transmits to the terminal device 120 a plurality of repetitions of the control information on the channel based on the resource configuration, a TCI state of the plurality of TCI states corresponding to at least one of the plurality of repetitions

In some embodiments, determining the resource configuration comprises: determining a search space associated with the plurality of TCI states, and transmitting the plurality of repetitions comprises: transmitting the plurality of repetitions within a transmission occasion of the search space.

In some embodiments, transmitting the plurality of repetitions within the transmission occasion of the search space comprises: determining, for a first TCI state of the plurality of TCI states, a first set of frequency domain resources configured for a control resource set associated with the search space; determining, for a second TCI state of the plurality of TCI states, a second set of frequency domain resources configured for the control resource set, the first set of frequency domain resources being non-overlapped with the second set of frequency domain resources in frequency domain; transmitting a first repetition with the first TCI state using the first set of frequency domain resources; and transmitting a second repetition with the second TCI state using the second set of frequency domain resources.

In some embodiments, transmitting the plurality of repetitions within the transmission occasion of the search space comprises: determining a plurality of time intervals within the transmission occasion of the search space based on a time duration of a control resource set associated with the search space, the plurality of time intervals being non-overlapped with each other in time domain; and transmitting a repetition of the plurality of repetitions within a respective one of the plurality of time intervals.

In some embodiments, determining the resource configuration comprises: determining a search space associated with the plurality of TCI states, and transmitting the plurality of repetitions comprises: transmitting the plurality of repetitions across different transmission occasions of the search space.

In some embodiments, determining the resource configuration comprises: determining a control resource set is associated with the plurality of TCI states, and transmitting the plurality of repetitions comprises: transmitting the plurality of repetitions across a plurality of search spaces associated with the control resource set.

In some embodiments, determining the resource configuration comprises: determining a plurality of control resource sets, each of the plurality of control resource sets being associated with a respective one of the plurality of TCI states, and transmitting the plurality of repetitions comprises: transmitting the plurality of repetitions across the plurality of control resource sets.

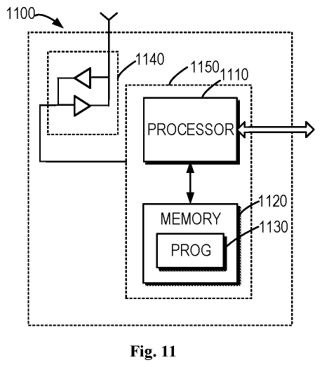

FIG. 11 is a simplified block diagram of a device 1100 that is suitable for implementing embodiments of the present disclosure. The device 1100 can be considered as a further example implementation of the network device 110 or the terminal device 120 as shown in FIG. 1. Accordingly, the device 1100 can be implemented at or as at least a part of the network device 110 or the terminal device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3, FIG. 9 and/or FIG. 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication comprising:
determining, at a terminal device, a resource configuration for control information on a channel between the terminal device and a network device, the resource configuration being associated with a plurality of Transmission Configuration Indicator (TCI) states for the channel; and
detecting a plurality of repetitions of the control information on the channel from the network device based on the resource configuration, a TCI state of the plurality of TCI states corresponding to at least one of the plurality of repetitions.

2. The method of claim 1, wherein determining the resource configuration comprises:
determining a search space associated with the plurality of TCI states, and
wherein detecting the plurality of repetitions comprises:
detecting the plurality of repetitions within a transmission occasion of the search space.

3. The method of claim 2, wherein detecting the plurality of repetitions within the transmission occasion of the search space comprises:
determining, for a first TCI state of the plurality of TCI states, a first set of frequency domain resources configured for a control resource set associated with the search space;
determining, for a second TCI state of the plurality of TCI states, a second set of frequency domain resources configured for the control resource set, the first set of frequency domain resources being non-overlapped with the second set of frequency domain resources in frequency domain;
detecting a first repetition with the first TCI state using the first set of frequency domain resources; and
detecting a second repetition with the second TCI state using the second set of frequency domain resources.

4. The method of claim 2, wherein detecting the plurality of repetitions within the transmission occasion of the search space comprises:
determining a plurality of time intervals within the transmission occasion of the search space based on a time duration of a control resource set associated with the search space, the plurality of time intervals being non-overlapped with each other in time domain; and
detecting a repetition of the plurality of repetitions within a respective one of the plurality of time intervals.

5. The method of claim 1, wherein determining the resource configuration comprises:
determining a search space associated with the plurality of TCI states, and
wherein detecting the plurality of repetitions comprises:
detecting the plurality of repetitions across different transmission occasions of the search space.

6. The method of claim 1, wherein determining the resource configuration comprises:
determining a control resource set associated with the plurality of TCI states, and
wherein detecting the plurality of repetitions comprises:
detecting the plurality of repetitions across a plurality of search spaces associated with the control resource set.

7. The method of claim 1, wherein determining the resource configuration comprises:
determining a plurality of control resource sets, each of the plurality of control resource sets being associated with a respective one of the plurality of TCI states, and
wherein detecting the plurality of repetitions comprises:
detecting the plurality of repetitions across the plurality of control resource sets.

8. The method of claim 1, wherein detecting the plurality of repetitions comprises:
determining a number of control channel elements (CCEs) associated with a TCI state of the plurality of TCI states;
determining indexes of the CCEs associated with the TCI state of the plurality of TCI states based on the number of the CCEs; and
detecting a repetition of the plurality of repetitions corresponding to the TCI state based on the indexes.

9. A method of communication comprising:
determining, at a network device, a resource configuration for transmitting control information on a channel between a terminal device and the network device, the resource configuration being associated with a plurality of Transmission Configuration Indicator (TCI) states for the channel; and
transmitting to the terminal device a plurality of repetitions of the control information on the channel based on the resource configuration, a TCI state of the plurality of TCI states corresponding to at least one of the plurality of repetitions.

10. The method of claim 9, wherein determining the resource configuration comprises:
determining a search space associated with the plurality of TCI states, and
wherein transmitting the plurality of repetitions comprises:
transmitting the plurality of repetitions within a transmission occasion of the search space.

11. The method of claim 10, wherein transmitting the plurality of repetitions within the transmission occasion of the search space comprises:
determining, for a first TCI state of the plurality of TCI states, a first set of frequency domain resources configured for a control resource set associated with the search space;
determining, for a second TCI state of the plurality of TCI states, a second set of frequency domain resources configured for the control resource set, the first set of frequency domain resources being non-overlapped with the second set of frequency domain resources in frequency domain;
transmitting a first repetition with the first TCI state using the first set of frequency domain resources; and
transmitting a second repetition with the second TCI state using the second set of frequency domain resources.

12. The method of claim 10, wherein transmitting the plurality of repetitions within the transmission occasion of the search space comprises:
determining a plurality of time intervals within the transmission occasion of the search space based on a time duration of a control resource set associated with the search space, the plurality of time intervals being non-overlapped with each other in time domain; and
transmitting a repetition of the plurality of repetitions within a respective one of the plurality of time intervals.

13. The method of claim 9, wherein determining the resource configuration comprises:
determining a search space associated with the plurality of TCI states, and
wherein transmitting the plurality of repetitions comprises:
transmitting the plurality of repetitions across different transmission occasions of the search space.

14. The method of claim 9, wherein determining the resource configuration comprises:
determining a control resource set is associated with the plurality of TCI states, and
wherein transmitting the plurality of repetitions comprises:
transmitting the plurality of repetitions across a plurality of search spaces associated with the control resource set.

15. The method of claim 9, wherein determining the resource configuration comprises:
determining a plurality of control resource sets, each of the plurality of control resource sets being associated with a respective one of the plurality of TCI states, and
wherein transmitting the plurality of repetitions comprises:
transmitting the plurality of repetitions across the plurality of control resource sets.

16. A terminal device comprising:
a processor; and
a memory coupled to the processor and storing instructions thereon, the instructions, when executed by the processor, causing the terminal device to perform acts comprising:
determining a resource configuration for control information on a channel between the terminal device and a network device, the resource configuration being associated with a plurality of Transmission Configuration Indicator (TCI) states for the channel; and
detecting a plurality of repetitions of the control information on the channel from the network device based on the resource configuration, a TCI state of the plurality of TCI states corresponding to at least one of the plurality of repetitions.

17. The device of claim 16, wherein determining the resource configuration comprises:
determining a search space associated with the plurality of TCI states, and
wherein detecting the plurality of repetitions comprises:
detecting the plurality of repetitions within a transmission occasion of the search space.

18. The device of claim 17, wherein detecting the plurality of repetitions within the transmission occasion of the search space comprises:
determining, for a first TCI state of the plurality of TCI states, a first set of frequency domain resources configured for a control resource set associated with the search space;
determining, for a second TCI state of the plurality of TCI states, a second set of frequency domain resources configured for the control resource set, the first set of frequency domain resources being non-overlapped with the second set of frequency domain resources in frequency domain;
detecting a first repetition with the first TCI state using the first set of frequency domain resources; and
detecting a second repetition with the second TCI state using the second set of frequency domain resources.

19. The device of claim 17, wherein detecting the plurality of repetitions within the transmission occasion of the search space comprises:
determining a plurality of time intervals within the transmission occasion of the search space based on a time duration of a control resource set associated with the search space, the plurality of time intervals being non-overlapped with each other in time domain; and
detecting a repetition of the plurality of repetitions within a respective one of the plurality of time intervals.

20. The device of claim 16, wherein determining the resource configuration comprises:
determining a search space associated with the plurality of TCI states, and
wherein detecting the plurality of repetitions comprises:
detecting the plurality of repetitions across different transmission occasions of the search space.

21. The device of claim 16, wherein determining the resource configuration comprises:
determining a control resource set associated with the plurality of TCI states, and
wherein detecting the plurality of repetitions comprises:
detecting the plurality of repetitions across a plurality of search spaces associated with the control resource set.

22. The device of claim 16, wherein determining the resource configuration comprises:
determining a plurality of control resource sets, each of the plurality of control resource sets being associated with a respective one of the plurality of TCI states, and
wherein detecting the plurality of repetitions comprises:
detecting the plurality of repetitions across the plurality of control resource sets.

23. The device of claim 16, wherein detecting the plurality of repetitions comprises:
determining a number of control channel elements (CCEs) associated with a TCI state of the plurality of TCI states;
determining indexes of the CCEs associated with the TCI state of the plurality of TCI states based on the number of the CCEs; and
detecting a repetition of the plurality of repetitions corresponding to the TCI state based on the indexes.

24. A network device comprising:
a processor; and
a memory coupled to the processor and storing instructions thereon, the instructions, when executed by the processor, causing the terminal device to perform acts comprising:
determining a resource configuration for transmitting control information on a channel between a terminal device and the network device, the resource configuration being associated with a plurality of Transmission Configuration Indicator (TCI) states for the channel; and
transmitting to the terminal device a plurality of repetitions of the control information on the channel based on the resource configuration, a TCI state of the plurality of TCI states corresponding to at least one of the plurality of repetitions.

25. The device of claim 24, wherein determining the resource configuration comprises:
determining a search space associated with the plurality of TCI states, and
wherein transmitting the plurality of repetitions comprises:
transmitting the plurality of repetitions within a transmission occasion of the search space.

26. The device of claim 25, wherein transmitting the plurality of repetitions within the transmission occasion of the search space comprises:
determining, for a first TCI state of the plurality of TCI states, a first set of frequency domain resources configured for a control resource set associated with the search space;
determining, for a second TCI state of the plurality of TCI states, a second set of frequency domain resources configured for the control resource set, the first set of frequency domain resources being non-overlapped with the second set of frequency domain resources in frequency domain;
transmitting a first repetition with the first TCI state using the first set of frequency domain resources; and
transmitting a second repetition with the second TCI state using the second set of frequency domain resources.

27. The device of claim 26, wherein transmitting the plurality of repetitions within the transmission occasion of the search space comprises:
determining a plurality of time intervals within the transmission occasion of the search space based on a time duration of a control resource set associated with the search space, the plurality of time intervals being non-overlapped with each other in time domain; and
transmitting a repetition of the plurality of repetitions within a respective one of the plurality of time intervals.

28. The device of claim 24, wherein determining the resource configuration comprises:
determining a search space associated with the plurality of TCI states, and
wherein transmitting the plurality of repetitions comprises:
transmitting the plurality of repetitions across different transmission occasions of the search space.

29. The device of claim 24, wherein determining the resource configuration comprises:
determining a control resource set is associated with the plurality of TCI states, and
wherein transmitting the plurality of repetitions comprises:
transmitting the plurality of repetitions across a plurality of search spaces associated with the control resource set.

30. The device of claim 24, wherein determining the resource configuration comprises:
determining a plurality of control resource sets, each of the plurality of control resource sets being associated with a respective one of the plurality of TCI states, and
wherein transmitting the plurality of repetitions comprises:
transmitting the plurality of repetitions across the plurality of control resource sets.

31. A computer readable medium having instructions stored thereon, the instructions, when executed on at least one processor, causing the at least one processor to perform the method according to any of claims 1 to 8.

32. A computer readable medium having instructions stored thereon, the instructions, when executed on at least one processor, causing the at least one processor to perform the method according to any of claims 9 to 15.
